(19) United States
(12) Patent Application Publication
(10) Pub. No.: US 2008/0065890 A1
(43) Pub. Date: Mar. 13, 2008

(54) SECURE SUPPORT FOR HOP-BY-HOP ENCRYPTED MESSAGING

(75) Inventor: Soren K. Lundsgaard, Inverness, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/530,667

(22) Filed: Sep. 11, 2006

(51) Int. Cl. H04L 9/00

(52) U.S. Cl. 713/171

(57) ABSTRACT

The disclosure relates to reducing the risk of security breaches in a multi-hop network. A decryption engine can decrypt at least a portion of a first encrypted packet using a first pair-wise transient key (PTK) to generate a first decrypted packet. A processor can then process the first decrypted packet to generate decrypted extracted information (DEI). An Operating System (OS) can receive the DEI from the processor, and then generate a forward message when the first encrypted packet is to be forwarded to the next hop node. The processor can then determine a destination address, a next hop address, and a second PTK associated with the next hop address from a key table. The decryption engine uses the first PTK to decrypt the first encrypted packet, and the encryption engine can use the second PTK to encrypt a first decrypted packet to generate a second encrypted packet.

### FIELD OF THE INVENTION

The present invention relates generally to wireless communications and more particularly to improving security of an intermediate node used in a multi-hop network.

### BACKGROUND

Types of wireless networks include infrastructure-based wireless networks and ad hoc wireless networks.

Ad hoc networks are self-forming networks which can operate in the absence of any fixed infrastructure, and in some cases the ad hoc network is formed entirely of mobile nodes. An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network. Links or connections between these nodes can change dynamically in an arbitrary manner as existing nodes move within the ad hoc network, as new nodes join or enter the ad hoc network, or as existing nodes leave or exit the ad hoc network. Because the topology of an ad hoc network can change significantly techniques are needed which can allow the ad hoc network to dynamically adjust to these changes. Due to the lack of a central controller, many network-controlling functions can be distributed among the nodes such that the nodes can self-organize and reconfigure in response to topology changes.

One characteristic of the nodes is that each node can directly communicate over a short range with nodes which are a single “hop” away. Such nodes are sometimes referred to as “neighbor nodes.” When a node transmits packets to a destination node and the nodes are separated by more than one hop (e.g., the distance between two nodes exceeds the radio transmission range of the nodes, or a physical barrier is present between the nodes), the packets can be relayed via intermediate nodes (“multi-hopping”) until the packets reach the destination node. In such situations, each intermediate node routes the packets (e.g., data and control information) to the next node along the route, until the packets reach their final destination. For relaying packets to the next node, each node should maintain routing information collected through conversation with neighboring nodes. The routing information can also be periodically broadcast in the network to reflect the current network topology. Alternatively, to reduce the amount of information transmitted for maintaining accurate routing information, the network nodes may exchange routing information only when it is needed. One approach for routing information, known as Mesh Scalable Routing (MSR), is described in U.S. Patent Application 20040143842 which is incorporated by reference herein in its entirety.

In some multi-hop networks (e.g., an 802.11 network), packets can be transmitted hop-by-hop over-the-air (OTA) between nodes. In some implementations, these packets are encrypted using a pair-wise transient key (PTK).

When an intermediate node in the multi-hop network receives a packet traversing a route to another “next hop” node, each encrypted packet is decrypted, passed to an Operating System (OS) in the intermediate node for routing, and then routing functionality in the intermediate node queues the unencrypted packet back through a hardware or Integrated Circuit (IC) portion of the node. Before the chipset sends the packet to the next hop node along the route to a destination node, the unencrypted packet is pushed to the OS for routing. The OS eventually sends the packet back to 802.11 hardware of the intermediate node to be forwarded to the next hop node along the route.

However, because unencrypted packet is sent between implementation layers (e.g., the hardware Integrated Circuit (IC) and the OS), those packets are potentially exposed to security problems in the OS. For example, because the OS is not secure, a hacker could read the unencrypted packets while they are unencrypted and being passed to the OS.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an exemplary communication network;

FIG. 2 is a block diagram of an exemplary node for use in the operation of some embodiments of the invention;

FIG. 3 is a block diagram of portions of the exemplary node of FIG. 2 for use in the operation of some embodiments of the invention;

FIG. 4 is a block diagram of portions of the exemplary node of FIG. 2 for use in the operation of some other embodiments of the invention; and

FIG. 5 is a flowchart showing an exemplary method for improving security of an intermediate node used in a multi-hop network in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to improving security of an intermediate node used in a multi-hop network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions for improving security of an intermediate node used in a multi-hop network as described herein. The non-processor circuits may include, but are not limited to, a radio receiver, a radio transmitter, signal drivers, clock circuits, power source circuits, and user input devices. As such, these functions may be interpreted as steps of a method for improving security of an intermediate node used in a multi-hop network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily designed to allow generating such software instructions and programs and ICs with minimal experimentation.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

### Exemplary Ad Hoc Multi-Hopping Network

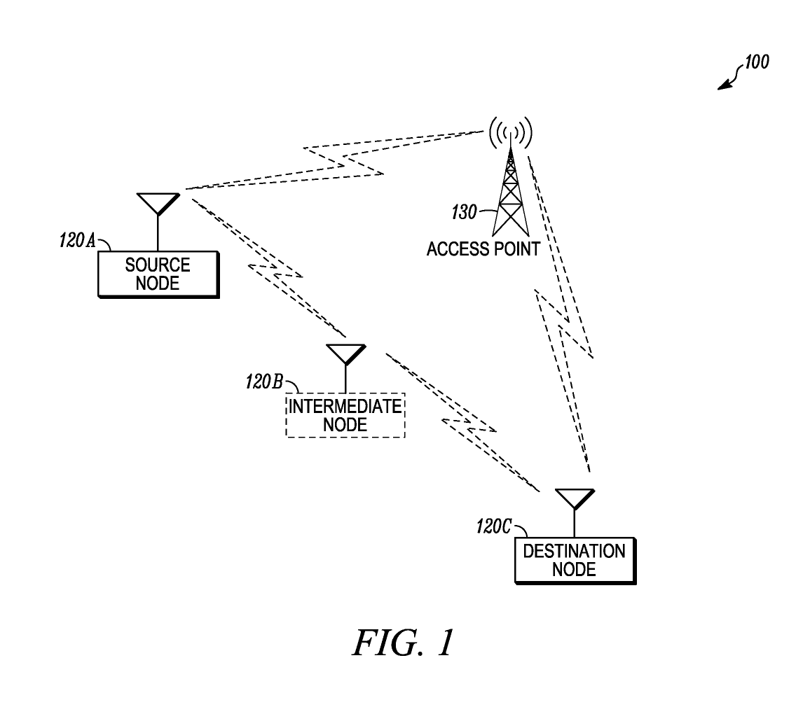

FIG. 1 is a block diagram of an exemplary ad hoc communication network 100 comprises a number of existing nodes 120 A-C.

The nodes 120A-120C typically support simultaneous operation in both infrastructureless mode and infrastructured mode and can move seamlessly between infrastructure-based networks (those including for example an Access Point AP 130) and client-based peer-to-peer networks which are free of any infrastructure.

The ad hoc multi-hopping communication network 100 can be created between a plurality of nodes 120A-120C each having wireless repeater and/or routing capability, and optionally a wired Access Point (AP) 130. Clients can move seamlessly between infrastructure-based networks and client-based peer-to-peer networks. It will be appreciated by those of ordinary skill in the art that while the ad hoc network 100 in FIG. 1 is shown as operating in an infrastructured mode (e.g., including APs and/or cellular base stations), the ad hoc network 100 of FIG. 1 does not require any network infrastructure to be present. Rather, the nodes 120A-120C typically support simultaneous operation in both infrastructureless mode and infrastructured mode.

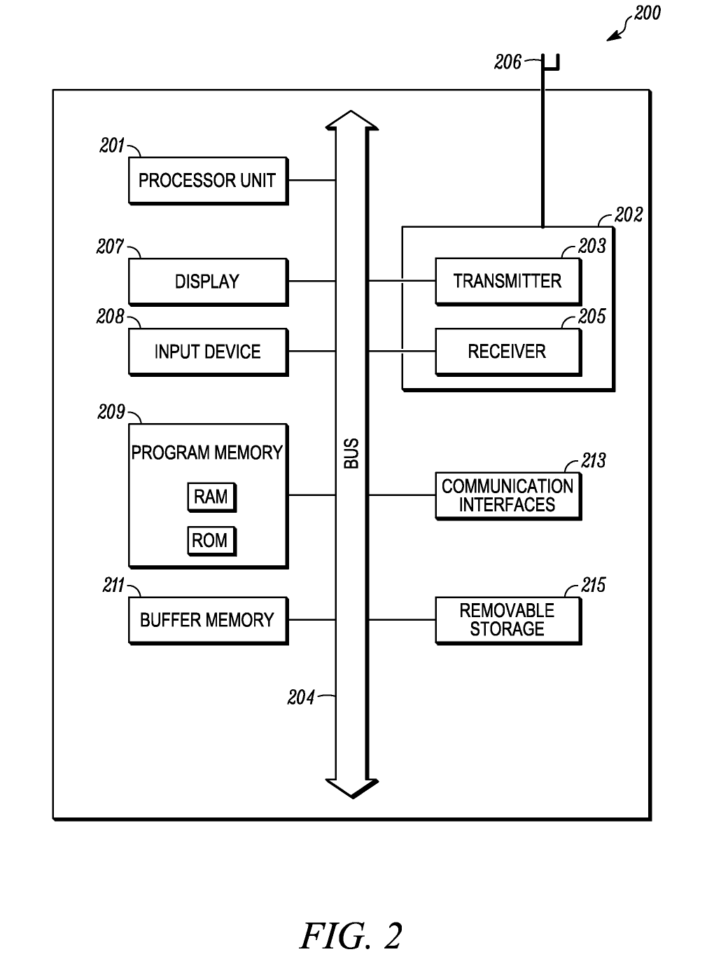

In the ad hoc multi-hopping network 100, communications to and/or from nodes 120A-120C can “hop” through each other to reach other nodes 120A-120C in the network. The nodes 120A-120C can generally be wireless devices designed to allow receiving of packetized audio, video and/or data information. Some of the components in an exemplary node, such as an exemplary processor, transmitter, receiver and antenna, are described below in FIG. 2. The nodes 120A-120C can exchange information as data packets transmitted over carrier frequencies, each of which includes one or more wireless communication channels.

In infrastructure mode, the access point AP 130 is typically coupled to a wired network (not shown) and can provide one or more sources of audio, video and/or data information. The access point AP 130 may be, for example, a cellular base station or other wireless access point.

Although not shown in FIG. 1, it will be appreciated by those of ordinary skill in the art that the nodes 120A-120C, can also communicate information packets with a cellular-based network (not shown) over wireless communication medium, each of which includes one or more wireless communication channels depending on the multiple access scheme utilized in the cellular-based network.

Exemplary Node

FIG. 2 is a block diagram of an exemplary node 200. The node 200 comprises a processor 201, a transceiver 202 including a transmitter circuitry 203 and a receiver circuitry 205, an antenna 206, a display 207, an input device 208, a program memory 209 for storing operating instructions that are executed by the processor 201, a buffer memory 211, one or more communication interfaces 213, and a removable storage unit 215. Although not shown, the node 200 also preferably includes an antenna switch, duplexer, circulator, or other highly isolative means (not shown) for intermittently providing information packets from the transmitter circuitry 203 to the antenna 206 and from the antenna 206 to the receiver circuitry 205. The node 200 is preferably an integrated unit containing at least all the elements depicted in FIG. 2, as well as any other elements necessary for the node 200 to perform its particular functions. Alternatively, the node 200 may comprise a collection of appropriately interconnected units or devices, wherein such units or devices perform functions that are equivalent to the functions performed by the elements of the node 200. For example, the node 200 may comprise a laptop computer and a wireless LAN (local area network) card.

The processor 201 preferably includes one or more microprocessors, microcontrollers, DSPs (digital signal processors), state machines, logic circuitry, or any other device or devices that process information based on operational or programming instructions. Such operational or programming instructions are preferably stored in the program memory 209. The program memory 209 may be an IC (integrated circuit) memory chip containing any form of RAM (random-access memory) or ROM (read-only memory), a floppy disk, a CD-ROM (compact disk read-only memory), a hard disk drive, a DVD (digital video disc), a flash memory card or any other medium for storing digital information. One of ordinary skill in the art will recognize that when the processor 201 has one or more of its functions performed by a state machine or logic circuitry, the memory 209 containing the corresponding operational instructions may be embedded within the state machine or logic circuitry. The operations performed by the processor 201 and the rest of the node 200 are described in detail below.

The transmitter circuitry 203 and the receiver circuitry 205 enable the node 200 to communicate information packets to and acquire information packets from the other nodes. In this regard, the transmitter circuitry 203 and the receiver circuitry 205 include conventional circuitry to enable digital or analog transmissions over a wireless communication channel. The transmitter circuitry 203 and the receiver circuitry 205 are designed to operate over both a cellular air interface (e.g., Global System for Mobile communication (GSM), Code Division Multiple Access (CDMA), Wide-band CDMA (WCDMA), Universal Mobile Telecommunications System (UMTS), and the like) and an ad hoc networking air interface (e.g., BLUETOOTH, 802.11 WLAN (wireless local area network), 802.16 WiMax, and the like)

The implementations of the transmitter circuitry 203 and the receiver circuitry 205 depend on the implementation of the node 200. For example, the transmitter circuitry 203 and the receiver circuitry 205 can be implemented as an appropriate wireless modem, or as conventional transmitting and receiving components of two-way wireless communication devices. In the event that the transmitter circuitry 203 and the receiver circuitry 205 are implemented as a wireless modem, the modem can be internal to the node 200 or insertable into the node 200 (e.g., embodied in a wireless radio frequency (RF) modem implemented on a Personal Computer Memory Card International Association (PCMCIA) card). For a wireless communication device, the transmitter circuitry 203 and the receiver circuitry 205 are preferably implemented as part of the wireless device hardware and software architecture in accordance with known techniques. Most, if not all, of the functions of the transmitter circuitry 203 and/or the receiver circuitry 205 may be implemented in a processor, such as the processor 201. However, the processor 201, the transmitter circuitry 203, and the receiver circuitry 205 have been artificially partitioned herein to facilitate a better understanding.

The receiver circuitry 205 is designed to allow receiving of RF signals from within at least one bandwidth and optionally more bandwidths, if the communications with the proximate device are in a frequency band other than that of the network communications. The receiver circuitry 205 may optionally comprise a first receiver and a second receiver, or one receiver designed to allow receiving within two or more bandwidths. The transceiver 202 includes at least one set of transmitter circuitry 203. The at least one transmitter 203 may be designed to allow transmitting to multiple devices on multiple frequency bands. As with the receiver 205, dual transmitters 203 may optionally be employed where one transmitter is for the transmission to a proximate node or direct link establishment to WLAN's and the other transmitter is for transmission to a cellular base station.

The antenna 206 comprises any known or developed structure for radiating and receiving electromagnetic energy in the frequency range containing the wireless carrier frequencies.

The buffer memory 211 may be any form of volatile memory, such as RAM, and is used for temporarily storing received information packets in accordance with the present invention.

When the node 200 is constructed to receive video information from a video source, the node 200 preferably further includes a video decoder designed to allow decoding the current Moving Picture Experts Group (MPEG) standard or some other video decoding standard. When the node 200 is further designed to allow transmitting video information, the node 200 preferably further includes a video encoder designed to allow encoding the video data into at least one of the foregoing video standards. Such video encoder and decoder is preferably implemented as part of the processor 201.

Techniques and technologies are provided for reducing the risk of security breaches in a multi-hop network, such as a multi-hop ad hoc network 100 of FIG. 1, which provides hop-by-hop security. As used herein, the term “multi-hop network” refers to any type of wireless network which employs routing protocols among nodes which are part of a network. The multi-hop network 100 of FIG. 1 includes, for example, an intermediate node 120B located along a route between a source node 120A and a destination node 120C.

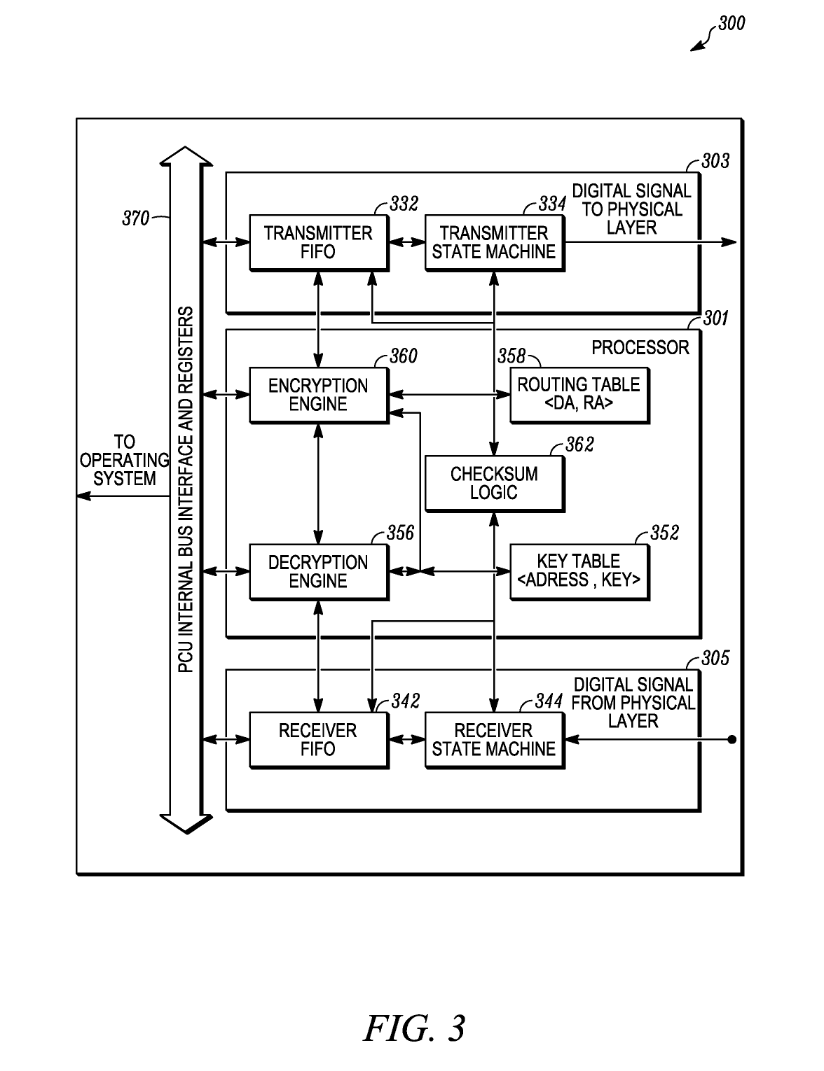

FIG. 3 is a block diagram of portions 300 of the exemplary node of FIG. 2 for use in the operation of some embodiments of the invention.

The intermediate node 120B comprises a receiver 305 comprising a receive buffer (FIFO) 342 and a receiver state machine 344, a processor 301 which includes a key table 352 configured to store key information, a decryption engine 356, a routing table 358 configured to store routing information and an encryption engine 360 linked to the decryption engine 356 by a buffer or pipeline, and checksum logic 362. A process control unit (PCU) internal bus 370 interfaces the hardware (or Integrated Circuit portion) of the node 300 to an Operating System (OS) (not shown). A transmitter 303 includes a transmit buffer 332, such as a First-In-First-Out (FIFO) buffer, and transmitter state machine 334. Although the key table 352, decryption engine 356, routing table 358, encryption engine 360, and checksum logic 362 are shown as being implemented in the processor 301, it will be appreciated by those skilled in the art that these components and modules could be implemented in other portions of the node 300, such as program memory 209 of FIG. 2, or as stand alone components/modules.

The receiver 305 can receive a first packet over a wireless channel which can be stored in the receiver FIFO 342. The first packet has a particular type (e.g., a specific message type, subtype) associated therewith. The processor 301 can confirm that the first packet comprises a first encrypted packet with an unencrypted header, determine a first pair-wise transient key (PTK) associated with a transmit address of the first packet from the key table 352, and determine information in the first encrypted packet which needs to be extracted.

The decryption engine 356 can decrypt at least a portion of the first encrypted packet using the first PTK to generate a first decrypted packet.

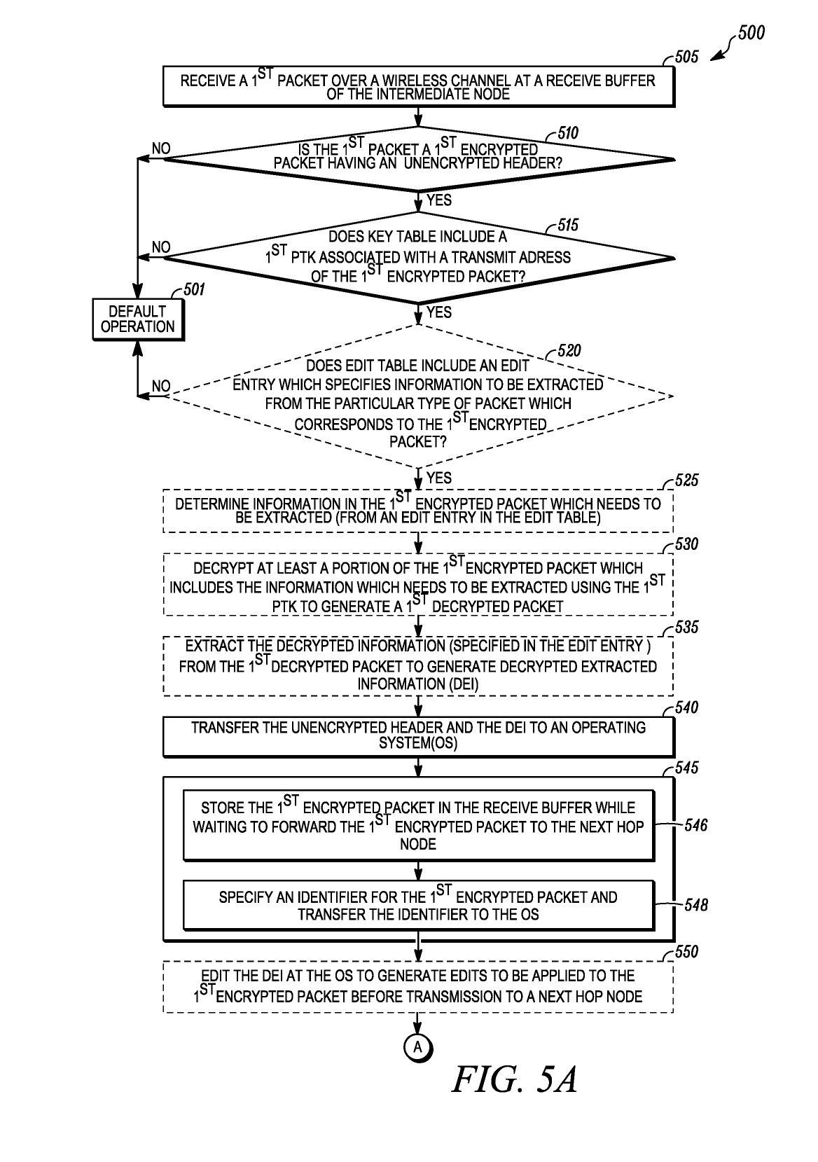

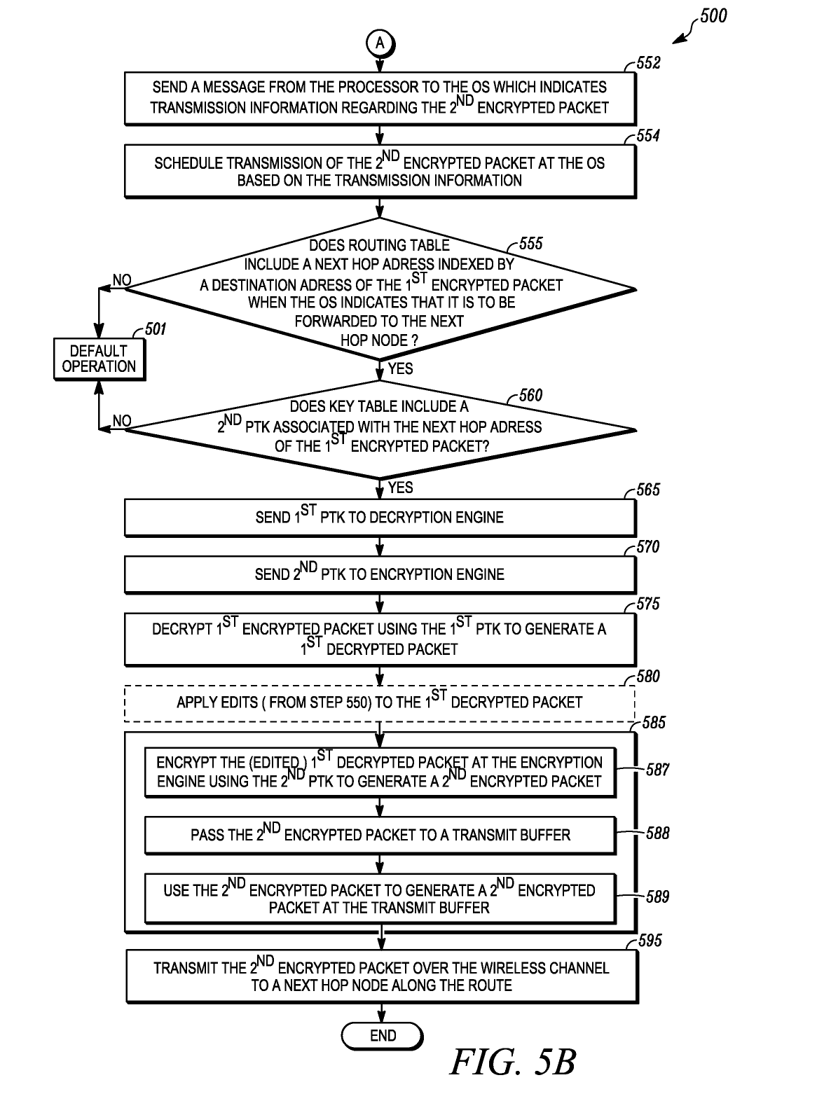

The processor 301 can then extract decrypted information from the first decrypted packet to generate decrypted extracted information (DEI). Examples of DEI are discussed below with reference to FIG. 5. The receiver FIFO 342 stores the first encrypted packet while waiting to forward the first encrypted packet to a next hop node.

The Operating System (OS) can receive the unencrypted header and the decrypted extracted information (DEI) from the processor 301, and then generate a forward message when the first encrypted packet is to be forwarded to the next hop node along the route to the destination address (DA).

Responsive to the forward message from the OS the processor 301 can then determine a destination address (DA) of the first encrypted packet from the routing table 358, and then determine, based on the destination address (DA), whether the routing table 358 includes a next hop address of the first encrypted packet.

If the routing table 358 includes the next hop address, the processor 301 can then determine a second pair-wise transient key (PTK) associated with the next hop address from the key table 352.

The decryption engine 356 receives the first PTK from the processor 301 and the first encrypted packet from the receiver FIFO 342, and uses the first PTK to decrypt the first encrypted packet and generate a first decrypted packet. The encryption engine 360 receives the second PTK from the processor 301 and the first decrypted packet from the decryption engine 356, and can use the second PTK to encrypt the first decrypted packet to generate a second encrypted packet.

The transmit buffer receives the second encrypted packet to generate a second encrypted packet. The processor 301 sends a message to the OS which comprises transmission information regarding the second encrypted packet. The transmission information comprises, for example, a transmit buffer location of the second encrypted packet and priority information for the second encrypted packet. The OS can schedule transmission of the second encrypted packet based on the transmission information. The transmitter 303 can then transmit the second encrypted packet over the wireless channel to the next hop node along the route.

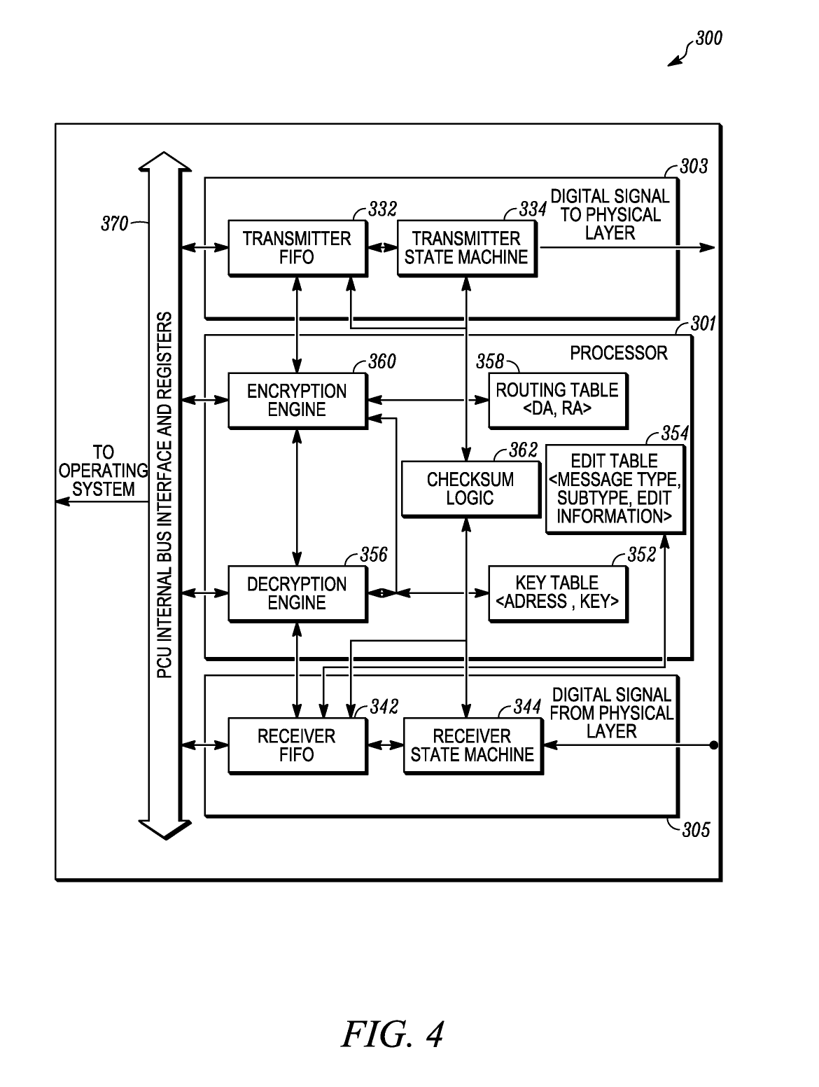

FIG. 4 is a block diagram of portions 300 of the exemplary node of FIG. 2 for use in the operation of some other embodiments of the invention. This embodiment includes similar components to those shown in FIG. 3 and for sake of simplicity redundant components will not be described again. In addition to the components shows in FIG. 3, the portions 300 of the exemplary node of FIG. 4 further include an edit table 354 that is configured to store edit entries. Each edit entry includes information to be extracted from a packet which has a specific message type and subtype. The information to be extracted from packets which have a specific message type and subtype can specify particular bytes or bits to be extracted from that particular packet. Depending on the implementation, the information that is to be extracted from the packet may comprise, for example, payload information and/or header information such as routing information included in the header. This information can be specified as a sequence of bytes which are to be extracted for that specific message type. Examples of the operational distinctions when the edit table 354 and edit entries are implemented will now be described below.

The processor 301 can check the edit entries in the edit table 354 to determine if the edit table 354 includes an edit entry corresponding to the particular type of packet which has a specific message type and subtype which corresponds to the first encrypted packet. The edit entry specifies information to be extracted from the particular type (a specific message type, subtype) of packet which corresponds to the first encrypted packet. From the edit entry in the edit table 354 the processor 301 can determine the information in the first encrypted packet which needs to be extracted for use by the OS.

The decryption engine 356 can then use the first PTK to decrypt at least the portion of the first encrypted packet which includes the information which needs to be extracted (as specified by the edit entry) to generate a first decrypted packet. The processor 301 can extract the decrypted information specified in the edit entry which needs to be extracted from the first decrypted packet to generate the decrypted extracted information (DEI).

The processor 301 can specify an identifier for the first encrypted packet, and send the identifier to the OS. The OS can then edit the DEI to generate edits to be applied to the first encrypted packet before transmission to the next hop node. The processor 301 can then apply the edits to the first decrypted packet.

The encryption engine 360 can then encrypt the edited first decrypted packet using the second PTK to generate the second encrypted packet.

The operation of the exemplary embodiments shown in FIGS. 3 and 4 will now be described with reference to FIG. 5. FIG. 5 is a flowchart showing an exemplary method for improving security of an intermediate node 120B used in a multi-hop network 100 in accordance with some embodiments of the invention. The intermediate node 120B is located along a route between a source node 120A and a destination node 120C. In FIG. 5, the steps shown in a dotted line format are optional and part of a second embodiment such as that shown in FIG. 4. For sake of simplicity, these steps are included in the description of FIG. 5.

At step 505, a digital input signal is received by a receiver state machine 344 which includes a first packet that is received by the receiver over a wireless channel. The receiver state machine 344 generates a sequence of bits corresponding to the first packet and provides them to a receiver FIFO 342 of the intermediate node 120B. The first packet has a particular “type” associated therewith. For example, in one implementation, the first packet can include an indication that it is part of a hop-by-hop message (e.g., is four address WDS type message). Moreover, in some cases, the first packet can indicate that it has a privacy enhanced bit set (e.g., is a first encrypted packet).

At step 510, the processor 301 in the intermediate node 120B confirms whether the first packet comprises a first encrypted packet that includes an unencrypted header. If the first packet does not comprise a first encrypted packet, then the process 500 enters default or regular operation mode at step 501.

If the first packet comprises a first encrypted packet that includes an unencrypted header, then at step 515, the processor can determine if a key table 352 of the intermediate node 120B includes a first pair-wise transient key (PTK) associated with a transmit address (TA) of the first encrypted packet. It is noted that in IEEE 802.11 protocols, keys are symmetric and can be used to either encrypt or decrypt packets. Thus, in IEEE 802.11 implementations of the process 500, keys in the key table 352 are only indexed by the address of the other node. For example, if the network 100 of FIG. 1 is implemented such that it uses IEEE 802.11 protocols, when a packet arrives at intermediate node 120B from source node 120A, the transmit address of the packet is that of node 120A, and the receive address is 120B. In this case, the PTK used to decrypt this packet at intermediate node 120B is at a location in the key table 352 indexed by the address for source node 120A. As such, when intermediate node 120B sends a packet to destination node 120C (or alternatively a next hop node), intermediate node 120B encrypts the unencrypted packet with the key found at a location in the key table 352 indexed by the address of node 120C. Similarly, when intermediate node 120B sends a packet to node 120A, intermediate node 120B encrypts the unencrypted packet with the key found at a location in the key table 352 indexed by the address of node 120A.

If the key table 352 does not include the first PTK at step 515, then the process 500 enters default or regular operation mode at step 501.

If the key table 352 includes the first PTK, then the process 500 can proceed either to step 520 or step 540 depending upon the implementation. The processor 301 obtains the first PTK corresponding to the incoming packet's transmit address to decrypt the first encrypted packet so that it can forward the decrypted information to the operating system (OS) of the intermediate node 120B. In FIG. 5 it is noted that any steps marked in dotted-line type boxes are optional and are part of an exemplary implementation of the process 500.

As noted above, the edit table 354 includes a number of edit entries. Each edit entry includes information to be extracted from packets of particular types. At optional step 520, the processor 301 checks edit entries in an edit table 354 of the intermediate node 120B to determine if the edit table 354 includes an edit entry corresponding to the particular type of packet which corresponds to the first encrypted packet. The edit entry specifies information to be extracted from the particular type of packet which corresponds to the first encrypted packet. In this implementation, the processor 301 obtained the first PTK corresponding to the incoming packet's transmit address at step 515 to decrypt at least the bytes specified by the edit table 354. If, at step 520 it is determined that the edit table does not include an edit entry (which specifies information to be extracted from the particular type of packet which corresponds to the first encrypted packet), then the process 500 enters default or regular operation mode at step 501.

At optional step 525, the processor 301 can determine, from the edit entry in the edit table 354, information in the first encrypted packet which needs to be extracted. As noted above, the information specified in a particular edit entry for a packet, which has a specific message type and subtype, depends on the particular implementation. The information to be extracted from packets which have a specific message type, subtype can specify particular bytes or bits to be extracted from that particular packet. This information can be specified as a sequence of bytes which are to be extracted for that specific message type Depending on the implementation, the information that is to be extracted from the packet may comprise, for example, payload information and/or header information such as routing information included in the header. For instance, when the information specified in a particular edit entry comprise routing information, this information can comprise an unencrypted 802.11 header and/or other information needed to route packet as designated by specific bytes listed in the edit table 354. The information needed to route packet can also include, for example, route information, throughput, and any other routing metrics used by an intermediate node to determine optimal paths between a source/transmitter node and a destination/receiver node.

At optional step 530, the decryption engine 356 of the intermediate node 120B can decrypt at least a portion of the first encrypted packet which includes the information which needs to be extracted using the first PTK to generate a first decrypted packet. The decryption engine 356 can utilize any known decryption technique including, for example, stream decryption or block decryption.

As will be appreciated by those skilled in the art, some encryption and decryption engines operate on streams of information byte-by-byte or bit-by-bit (e.g., stream cipher or state cipher). A stream cipher is a symmetric cipher in which the plaintext digits are encrypted one at a time, and in which the transformation of successive digits varies during the encryption. An alternative name is a state cipher, as the encryption of each digit is dependent on the current state. In practice, the digits are typically single bits or bytes. The encryption or decryption engine maintains state information as it processes each byte of data (or bit of data) that it being encrypted or decrypted. For instance, in a stream cipher operation, to encrypt or decrypt bytes 100-150 of a particular packet, bytes 1-99 are encrypted or decrypted first so that when byte 100 is encrypted or decrypted, the encryption or decryption engine generates the correct value. In other words, the encryption or decryption engine cannot immediately jump to byte 100 and start encrypting or decrypting because bytes 1-99 affect the state of the encryption or decryption engine.

Other encryption and decryption engines operate on blocks of information block-by-block (e.g., block cipher). A block cipher is a symmetric key cipher which operates on fixed-length groups of bits referred to as “blocks.” Block ciphers operate on large blocks of digits with a fixed, unvarying transformation. Some modes of operation use a block cipher primitive in such a way that it then acts effectively as a stream cipher. Stream ciphers typically execute at a higher speed than block ciphers and have lower hardware complexity. When encrypting, a block cipher might take, for example, a 128-bit block of plaintext as input, and output a corresponding 128-bit block of ciphertext. The exact transformation is controlled using a second input—the secret key. To encrypt messages longer than the block size (128 bits in the above example), a mode of operation is used. Decryption is similar: the decryption algorithm takes, in this example, a 128-bit block of ciphertext together with the secret key, and yields the original 128-bit block of plaintext. For instance, in one implementation of a block cipher, the decryption routine needs to know the following information about the whole buffer to be decrypted. The decryption key, some initial state information about the entire sequence of blocks to be decrypted, and the data in block N−1. For example, to decrypt the 7th 128 bit block of data, the decryption routine needs to know the PTK used, an initial counter for the 1st block, and the encrypted data in block 6. With this information, it can decrypt block 7. Using block decryption, the process of decrypting data can skip forward to the block before the block of interest. For example, to decrypt block 7, the decryption engine could skip over blocks 1 through 5, load the information into the decryption engine (including the encrypted block 6), and then decrypt block 7.

As such, at step 530, the first encrypted packet is decrypted with the intention of extracting the information as specified in the edit table 354. In other words, after all of the edit text has been decrypted, there is no need to decrypt the rest of the packet. For example, in the context of a stream decryption, if the first encrypted packet comprises 1000 bytes, where bytes 1-99 are unencrypted header information (e.g., clear text), and bytes 100 through 1000 are encrypted, and the edit text for this type of packet indicates that bytes 200 . . . 250 should be decrypted, then it is not required that the entire first encrypted packet is decrypted, but it could be depending upon the specific implementation. Rather, it is only necessary to decrypt as much of the first encrypted packet (e.g., up to byte 250) as needed to provide the information specified in the edit table 354 that should be extracted from the first decrypted packet, so that the portion of the decrypted bytes (specified by the edit table 354) can be extracted from the first decrypted packet and passed up to the OS. Decryption can stop once the information (specified in the edit table 354) that should be extracted from the first decrypted packet (e.g., bytes 200 . . . 250) is decrypted. Any decrypted bytes (e.g., bytes 100 . . . 199) that are not needed by the OS (as specified by the edit table 354) can be discarded.

At optional step 535, the processor 301 can extract specific decrypted information (as specified in the edit entry) which needs to be extracted from the first decrypted packet to generate decrypted extracted information (DEI). As used herein, the term “decrypted extracted information (DEI)” refers to a portion or portions of the decrypted packet which is extracted from packets which have a specific message type, subtype. The DEI can specify particular bytes or bits to be extracted from that particular packet, and in some implementations, can be specified as a sequence of bytes which are to be extracted for that specific message type. Depending on the implementation, the DEI extracted from the packet may comprise, for example, payload information and/or header information such as routing information included in the header. For instance, when the information specified in a particular edit entry comprises routing information, this information can comprise an unencrypted 802.11 header and/or other information needed to route packet as designated by specific bytes listed in the edit table 354. The information needed to route packet can also include, for example, route information, throughput, and any other routing metrics used by an intermediate node to determine optimal paths between a source/transmitter node and a destination/receiver node. The DEI can be listed, for example, in an edit table 354 maintained in the hardware (e.g., Integrated Circuit (IC)) portion of an intermediate node 300.

As such, “sensitive” data that is hopping through an intermediate node in the ad hoc network (e.g., that is received by the intermediate node) is not passed up to the OS and resides only within the IC portion of the intermediate node (as opposed to the OS). Because there is no need to copy to upper layer buffer(s), the only data that is visible to upper layers is the same data that is going over the air (OTA) thereby making it harder to obtain access to the sensitive data.

At step 540, after extracting the relevant information, the processor 301 transfers the unencrypted header and the decrypted extracted information (DEI) over the bus 370 to the Operating System (OS) of the intermediate node 120B. In one implementation, only decrypted bytes specified in the edit table 354 are sent to the OS such that the upper layers receive only the appropriate information for the specific packet type. As will be described below at step 550, the OS can then send down new sequence of bytes to insert in place of those decrypted bytes. The new sequence of bytes that is modified is determined by the OS based on the particular edit entry. For example, in one implementation, the new sequence of bytes generated by the OS can relate to: an update to the payload information or an update to the header information. For instance, the header information includes routing information. An example of an update to the routing information may comprise, for example, an update to the hop count specified in the internal header, or an update to an end-to-end metric based on partial metrics recorded at the node.

At step 545, the processor 301 can store the first encrypted packet in the receiver FIFO 342 while waiting to forward the first encrypted packet to the next hop node. The processor 301 can also specify an identifier for the first encrypted packet, and transfer the identifier to the OS. For instance, the processor 301 can tag the packet with an identifier which is also transferred to the OS, and retain the encrypted packet on the IC tagged with that tag. As will be described below with reference to step 581, this identifier enables the OS to inform the processor 301 which packet it is providing edits for so that the processor 301 can apply the edits to the packet before re-encrypting it and transmitting it to the next hop node.

At optional step 550, the OS of the intermediate node 120B can edit the DEI to generate edits (e.g., replacement bytes) to be applied to the first encrypted packet before transmission to a next hop node. As used herein, the term “edits” refers to additions to, deletions from and/or changes to be applied to the header and/or payload of the first encrypted packet. For example, in one implementation, the upper layers can make adjustments to the routing information for the first encrypted packet according to proprietary or protocol dependent routing algorithms. For instance, some routing protocols require that data in a header portion is updated at each hop. The upper layers also need to ensure that the packet is properly queued according to Quality-of-Service (QoS) information contained in the packet which means that the editing table 354 needs to be set up so that QoS is returned to the OS as well as routing information. As such, edits (e.g., replacement bytes) are generated that will eventually be used between the decryption engine 356 and the encryption engine 360 to replace the DEI.

At step 552, the processor 301 sends a message to the OS which indicates transmission information regarding the second encrypted packet. The transmission information comprises a location in the transmitter FIFO 332 of the second encrypted packet and priority information for the second encrypted packet.

At step 554, the OS schedules transmission of the second encrypted packet based on the transmission information.

When the OS indicates to the processor 301 that the first encrypted packet is to be forwarded to the next hop node along the route to the destination address (DA), at step 555 the processor 301 can determine a destination address (DA) of the first encrypted packet from the routing table 358 of the intermediate node 120B, and a next hop address from the routing table 358 of the intermediate node 120B. In one implementation, the next hop address of the first encrypted packet is indexed by the destination address (DA) of the first encrypted packet.

If the processor 301 determines that the routing table 358 of the intermediate node 120B does not include a destination address (DA) of the first encrypted packet or a next hop address at step 555, then the process 500 enters default or regular operation mode at step 501.

At step 560, the processor 301 can determine a second pair-wise transient key (PTK) associated with the next hop address of the first encrypted packet from the key table 352 of the intermediate node 120B.

If the processor 301 can not determine a second pair-wise transient key (PTK) associated with the next hop address of the first encrypted packet from the key table 352 of the intermediate node 120B (at step 560), then the process 500 enters default or regular operation mode at step 501.

At step 565, the processor 301 can send the first PTK to the decryption engine 356, and at step 570, the processor 301 can send the second PTK to the encryption engine 360.

At step 575, the receiver FIFO 342 can pass the first encrypted packet to the decryption engine 356, and the decryption engine 356 can decrypt the first encrypted packet using the first PTK to generate a first decrypted packet. The first decrypted packet may comprise either a stream of bits, bytes, blocks or other data set depending on the decryption techniques implemented by the decryption engine 356.

The edits (e.g., replacement bytes) are transferred to the processor 301 when the OS tells the processor 301 to forward the packet to the next hop. At optional step 580, the processor 301 applies edits (e.g., replacement bytes) generated at step 550 to the first decrypted packet using any known mechanism for communicating between the encryption engine 360 and the decryption engine 356. As noted above, the encryption engine 360 is linked to the decryption engine 356 by a buffer or pipeline. In an alternative exemplary implementation, the encryption engine 360 and the decryption engine 356 could be the same engine with an appropriately sized buffer (not shown) between the encryption engine 360 and the decryption engine 356. Among other things, the buffer can hold encryption state information. The encryption state information allows the encryption engine 360 and the decryption engine 356 to switch between: decrypting the first decrypted packet to the unencrypted text, and encrypting the unencrypted text into the second encrypted packet. The buffer can separately store the encryption state information since both states will be in the buffer at a particular instance. The processor 301 can load the decryption engine 356 with the previous hop key, decrypt into the buffer, then load the next hop key and encrypt to transmitter FIFO 332, etc.

At step 585 the encryption engine 360 generates a second encrypted packet. As will now be described, in one exemplary implementation, the encryption engine 360 generates a second encrypted packet via steps 587-589. In this implementation, at step 587, the encryption engine 360, receives the edited first decrypted packet, encrypts the edited first decrypted packet using the second PTK to generate a second encrypted packet, and at step 588 passes the second encrypted packet to a transmitter FIFO 332. The transmitter FIFO 332 accumulates the second encrypted packet and, at step 589, eventually generates a second encrypted packet.

At step 595, the transmitter FIFO 332 passes the second encrypted packet to the transmitter state machine 334 which prepares the second encrypted packet to be transmitted to the next hop node. Among other things, the transmitter state machine 334 can add a Cyclic Redundancy Check (CRC) to the second encrypted packet, and then drive the transmitter 303 to transmit the second encrypted packet to the next hop node. The second encrypted packet can then be transmitted by the transmitter 303 over the wireless channel to a next hop node along the route.

In the foregoing specification, specific embodiments of the present invention have been described. However, one of ordinary skill in the art appreciates that various modifications and changes can be made without departing from the scope of the present invention as set forth in the claims below.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An intermediate node located along a route between a source node and a destination node, the intermediate node comprising:
a memory comprising a key table configured to store key information, and a routing table configured to store routing information;
a receiver comprising a receive buffer, the receiver configured to receive a first packet over a wireless channel and to store the first packet at the receive buffer, wherein the first packet has a particular type associated therewith;
a processor configured to confirm that the first packet comprises a first encrypted packet with an unencrypted header, to determine a first pair-wise transient key (PTK) associated with a transmit address of the first packet from the key table, and to determine information in the first encrypted packet which needs to be extracted;
a decryption engine configured to decrypt at least a portion of the first encrypted packet using the first PTK to generate a first decrypted packet, wherein the processor is configured to extract decrypted information from the first decrypted packet to generate decrypted extracted information (DEI), wherein the receive buffer is configured to store the first encrypted packet while waiting to forward the first encrypted packet to a next hop node;
an Operating System (OS) configured to receive the unencrypted header and the decrypted extracted information (DEI) from the processor, and to generate a forward message when the first encrypted packet is to be forwarded to the next hop node along the route to the destination address;
wherein the processor is further configured to determine, responsive to the forward message from the OS, a destination address of the first encrypted packet from the routing table, and to determine, based on the destination address, whether the routing table includes a next hop address of the first encrypted packet; and to determine a second pair-wise transient key (PTK) associated with the next hop address of the first encrypted packet from the key table if the routing table includes the next hop address;
wherein the decryption engine is further configured to receive the first PTK from the processor and the first encrypted packet from the receive buffer, and to decrypt the first encrypted packet using the first PTK to generate a first decrypted packet; and
an encryption engine configured to receive the second PTK from the processor and the first decrypted packet from the decryption engine, and to encrypt the first decrypted packet using the second PTK to generate a second encrypted packet.

2. An intermediate node according to claim 1, further comprising:
an edit table configured to store edit entries, wherein each edit entry includes information to be extracted from packets of particular types, and
wherein the processor is further configured to check the edit entries in the edit table to determine if the edit table includes an edit entry corresponding to the particular type of packet which corresponds to the first encrypted packet, wherein the edit entry specifies information to be extracted from the particular type of packet which corresponds to the first encrypted packet.

3. An intermediate node according to claim 2, wherein the processor is further configured to determine, from the edit entry in the edit table, the information in the first encrypted packet which needs to be extracted.

4. An intermediate node according to claim 3, wherein the decryption engine is further configured to decrypt at least a portion of the first encrypted packet which includes the information which needs to be extracted using the first PTK to generate a first decrypted packet.

5. An intermediate node according to claim 4, wherein the processor is further configured to extract the decrypted information specified in the edit entry from the first decrypted packet to generate the decrypted extracted information (DEI).

6. An intermediate node according to claim 5, wherein the processor is further configured to specify an identifier for the first encrypted packet, and send the identifier and the DEI to the OS, and
wherein the OS is further configured to edit the DEI to generate edits to be applied to the first encrypted packet before transmission to the next hop node.

7. An intermediate node according to claim 6, wherein the processor is further configured to receive the edits from the OS and to apply the edits to the first decrypted packet.

8. An intermediate node according to claim 7, wherein the encryption engine is further configured to receive the second PTK from the processor and the edited first decrypted packet from the decryption engine, and to encrypt the edited first decrypted packet using the second PTK to generate the second encrypted packet.

9. An intermediate node according to claim 1, further comprising:
a transmit buffer configured to receive the second encrypted packet to generate a second encrypted packet.
wherein the processor is further configured to send a message to the OS which comprises transmission information regarding the second encrypted packet; and
wherein the OS is further configured to schedule transmission of the second encrypted packet based on the transmission information, wherein the transmission information comprises a transmit buffer location of the second encrypted packet and priority information for the second encrypted packet.

10. An intermediate node according to claim 9, further comprising:
a transmitter configured to transmit the second encrypted packet over the wireless channel to the next hop node along the route.

11. At an intermediate node in a network having a route comprising a source node, a destination node and at least the intermediate node along the route between the source node and the destination node, a method comprising:
determining, from a key table of the intermediate node, a first pair-wise transient key (PTK) associated with a transmit address of a packet comprising a first encrypted packet with an unencrypted header;
determining information in the first encrypted packet which needs to be extracted; and decrypting, at a decryption engine of the intermediate node, at least a portion of the first encrypted packet using the first PTK to generate a first decrypted packet;
extracting decrypted information from the first decrypted packet to generate decrypted extracted information (DEI), and transferring the unencrypted header and the decrypted extracted information (DEI) to an Operating System (OS) of the intermediate node;
determining a destination address of the first encrypted packet from a routing table of the intermediate node, and determining, based on the destination address, whether the routing table includes a next hop address of the first encrypted packet when the OS indicates to the processor that the first encrypted packet is to be forwarded to the next hop node along the route to the destination address;
determining, from the key table of the intermediate node, a second pair-wise transient key (PTK) associated with the next hop address of the first encrypted packet;
sending the first PTK to the decryption engine, sending the first encrypted packet from the receive buffer through the decryption engine and decrypting the first encrypted packet using the first PTK to generate a first decrypted packet; and
sending the second PTK to the encryption engine, sending the first decrypted packet through the encryption engine, and encrypting the first decrypted packet using the second PTK to generate a second encrypted packet.

12. A method according to claim 11, further comprising:
receiving the first packet over a wireless channel at a receive buffer of the intermediate node, wherein the first packet has a particular type associated therewith; and
confirming, at the processor in the intermediate node, that the first packet comprises the unencrypted header and the first encrypted packet.

13. A method according to claim 11, further comprising:
checking edit entries in an edit table in the intermediate node to determine if the edit table includes an edit entry corresponding to the particular type of packet which corresponds to the first encrypted packet, wherein each edit entry includes information to be extracted from packets of particular types, and wherein the edit entry specifies information to be extracted from the particular type of packet which corresponds to the first encrypted packet.

14. A method according to claim 13, wherein determining information in the first encrypted packet which needs to be extracted, comprises:
determining, from an edit entry in the edit table, information in the first encrypted packet which needs to be extracted.

15. A method according to claim 14, wherein decrypting, at a decryption engine of the intermediate node, at least a portion of the first encrypted packet using the first PTK to generate a first decrypted packet, further comprises:
decrypting, at the decryption engine of the intermediate node, at least the portion of the first encrypted packet which includes the information which needs to be extracted using the first PTK to generate the first decrypted packet.

16. A method according to claim 15, wherein extracting decrypted information from the first decrypted packet to generate decrypted extracted information (DEI), further comprises:
extracting the decrypted information specified in the edit entry as needing to be extracted from the first decrypted packet to generate the decrypted extracted information (DEI).

17. A method according to claim 16, further comprising:
storing the first encrypted packet in the receive buffer while waiting to forward the first encrypted packet to the next hop node, specifying an identifier for the first encrypted packet, and transferring the identifier and the DEI to the OS of the intermediate node; and
editing the DEI at the OS of the intermediate node to generate edits to be applied to the first encrypted packet before transmission to a next hop node.

18. A method according to claim 17, further comprising:
sending the edits to the processor; and
applying edits to the first decrypted packet, and
wherein sending the first decrypted packet through the encryption engine, further comprises:
sending the edited first decrypted packet through the encryption engine; and
wherein encrypting the first decrypted packet using the second PTK to generate a second encrypted packet, further comprises:
encrypting the edited first decrypted packet using the second PTK to generate the second encrypted packet.

19. A method according to claim 11, further comprising:
sending the second encrypted packet to a transmit buffer;
using the second encrypted packet to generate a second encrypted packet at the transmit buffer;
sending a message from the processor to the OS which indicates transmission information regarding the second encrypted packet, wherein the transmission information comprises a transmit buffer location of the second encrypted packet and priority information for the second encrypted packet; and
scheduling, at the OS based on the transmission information, transmission of the second encrypted packet.

20. A method according to claim 19, further comprising:
transmitting the second encrypted packet over the wireless channel to the next hop node along the route.
